(19) United States
(12) Patent Application Publication
(10) Pub. No.: US 2002/0085492 A1
(43) Pub. Date: Jul. 4, 2002

(54) Apparatus for outputting a signal, a method for outputting the signal, and a computer-readable storage medium storing a computer-executable program for operating a computer to output the signal

(75) Inventors: Hiroaki Mukai, Tokyo (JP); Toshikazu Yoshida, Tokyo (JP); Seiji Kozaki, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: MITSUBISHI DENKI KABUSHIKI KAISHA, Chiyoda-ku (JP)

(21) Appl. No.: 09/880,917

(22) Filed: Jun. 15, 2001

(30) Foreign Application Priority Data
Dec. 28, 2000 (JP) 2000-400250

(51) Int. Cl. H04L 12/26

(52) U.S. Cl. 370/230; 370/468

(57) ABSTRACT

A counter of a transmission permitting signal counts a number of the transmission permitting signal which was not sent to a subscriber-side apparatus due to the opening of ranging window. A band controller allocates a band to the transmission permitting signal which was not sent so that the transmission permitting signal which was not sent and counted by the counter of the transmission permitting signal is sent prior to other signals in a next sending opportunity (next time frame for updating the band).

### BACKGROUND OF THE INVENTION

1. Field of the Invention

This invention relates to a technique for managing a bandwidth in an ATM (Asynchronous Transfer Mode)-PON (Passive Optical Network) system.

2. Description of the Related Art

FIG. 3 illustrates the ATM-PON system according to the related art disclosed in Japanese Unexamined Published Patent Application HEI 11-355301. In this system, a terminal apparatus of a subscriber line (OLT: Optical Line Terminal) and a plurality of terminal apparatuses in a network (ONT: Optical Network Terminal) mutually perform two-way communication.

Operations are explained.

In the ATM-PON system, a station-side apparatus 1 sends a transmission permitting signal to each of subscriber-side apparatuses 2-1˜2-N, specifying a time slot allocated to each of the subscriber-side apparatuses 2-1˜2-N for transmitting data to the station-side apparatus 1. A number of transmission permitting signals per a unit time is proportional to a bandwidth allocated to each of the subscriber-side apparatuses 2-1˜2-N. A bandwidth controller 6 notifies a generator 4 of the transmission permitting signal of a rate of sending the transmission permitting signal per the unit time.

If the subscriber-side apparatuses 2-1˜2-N have data to be transmitted, the subscriber-side apparatuses 2-1˜2-N transmit valid data in the specified time slot. If the subscriber-side apparatuses 2-1˜2-N have no data to be transmitted, the subscriber-side apparatuses 2-1˜2-N transmit invalid data in the specified time slot.

When the subscriber-side apparatuses 2-1˜2-N transmit data, the subscriber-side apparatuses 2-1˜2-N delay transmission of data by a delay time informed respectively by the station-side apparatus 1. Accordingly, even if distances between each of the subscriber-side apparatuses 2-1˜2-N and the station-side apparatus 1 are different from each other, time-division-multiplexing is possible.

When another subscriber-side apparatus 2-i is newly installed, the station-side apparatus 1 performs a procedure called ranging as stated below for determining the delay time for the subscriber-side apparatus 2-i.

With reference to FIG. 4, explanations are made on ranging. FIG. 4 illustrates time positions of each transmission permitting signal in normal time in (a).

A condition controller 5 instructs the generator 4 of the transmission permitting signal to send a transmission permitting signal for ranging to the newly installed subscriber-side apparatus 2-i of which delay time is unknown.

As illustrated in (b) of FIG. 4, the generator 4 of the transmission permitting signal does not send the transmission permitting signal to other subscriber-side apparatuses 2-1˜2-N while there is a possibility that a response is returned from the newly installed subscriber-side apparatus 2-i. Waiting time for the response from the newly installed subscriber-side apparatus 2-i is called as a ranging window.

When the response is returned from the subscriber-side apparatus 2-i, the station-side apparatus 1 measures the delay time. Then, the station-side apparatus 1 calculates an appropriate value of delay time for performing time-division-multiplexing based on the measured delay time, and informs the calculated value of delay time to the subscriber-side apparatus 2-i. The generator 4 of the transmission permitting signal places the transmission permitting signal in a queue, which can not be sent due to the opening of ranging window. When the ranging window is closed, the generator 4 of the transmission permitting signal sends the queuing transmission permitting signal.

In the ATM-PON system, dynamic bandwidth allocation is performed to adjust bandwidth allocation to each of the subscriber-side apparatuses 2-1˜2-N based on a usage condition of the bandwidth. Following is an example of the dynamic bandwidth allocation.

A congestion detector 7 detects a congestion state by counting valid data and invalid data sent from each of the subscriber-side apparatuses 2-1˜2-N or by receiving an information message informing the congestion state from each of the subscriber-side apparatus.

As illustrated in FIG. 6, the bandwidth controller 6 constantly provides a minimum guaranteed bandwidth (BW1_min, BW2_min, BW3_min, . . . ) to each of the subscriber-side apparatuses 2-1˜2-N. The bandwidth controller 6 increases a bandwidth for the subscriber-side apparatus 2-j in congestion state by allocating an excess bandwidth (BWj_ex).

The minimum guaranteed bandwidth is allocated to a traffic, which is intolerant to a delay such as CBR (Constant Bit Rate), prior to other traffic.

### SUMMARY OF THE INVENTION

In the ATM-PON system according to the related art, when the ranging window is opened, a bandwidth available for data transmission is reduced temporally. Then, the transmission permitting signal, which could not be sent due to the reduced bandwidth, is placed in a queue. After the ranging window is closed, the queuing transmission permitting signal is sent.

Therefore, it is impossible to allocate all the bandwidth of APON (ATM-PON) to the subscriber-side apparatuses. A reserve bandwidth for sending the queuing transmission permitting signal after the ranging window is closed is provided (FIG. 5), and a bandwidth after deducting the reserve bandwidth from an APON bandwidth is allocated to the subscriber-side apparatuses (FIG. 6).

When the reserve bandwidth is set at low level, a time for sending the queuing transmission permitting signal has to be long, and data have to remain in the subscriber-side apparatuses. This causes degradation of communication quality especially in a CBR path. When the reserve bandwidth is set at high level, the queuing transmission permitting signal can be sent in short time. However, when the ranging window is not opened, the reserve bandwidth prevents from effective bandwidth allocation.

Further, in the dynamic bandwidth allocation, especially in a system where the station-side apparatus counts valid data received from the subscriber-side apparatuses in the station-side apparatus and changes allocation of the bandwidth, the station-side apparatus detects that a usage rate of the bandwidth is low when the ranging window is opened, and after the ranging window is closed, since the queuing transmission permitting signal is sent, the station-side apparatus detects the usage rate becomes higher. Therefore, a calculation of the usage rate has to be inaccurate, and that causes inefficient bandwidth allocation.

This invention is intended to solve the above-stated problems. It is one of objects of this invention to reduce the delay in the data transmission due to the opening of ranging window, and utilize the APON bandwidth effectively.

According one aspect of this invention, in an apparatus for outputting a signal, the signal for a data communication apparatus is output to the data communication apparatus in a constant total output amount of the signal per a unit time and output of the signal is stopped during a certain time of stopping output of the signal. The apparatus includes a signal output schedule setter for setting a signal output schedule for each of the unit time by defining a certain output amount of the signal out of the total output amount of the signal per the unit time as a first output group and further defining a difference between the total output amount of the signal per the unit time and the output amount of the signal in the first output group as at least more than one second output group, and when an output delay signal, which is not output within a specific unit time, is caused by stopping output due to at least partial overlapping of the specific unit time and the time of stopping output of the signal, and therefore the total output amount of the signal in the specific unit time is reduced, for setting the signal output schedule for outputting the output delay signal, which is not output within the specific unit time, in another unit time following the specific unit time by reducing the output amount of the signal in at least one second output group in the other unit time.

According another aspect of this invention, in an apparatus for outputting a signal, the signal for a data communication apparatus is output to the data communication apparatus in a constant total output amount of the signal per a unit time and output of the signal is stopped during a certain time of stopping output of the signal. The apparatus includes a signal output schedule setter for setting a signal output schedule for each of the unit time by defining a certain output amount of the signal out of the total output amount of the signal per the unit time as a first output group and further defining a difference between the total output amount of the signal per the unit time and the output amount of the signal in the first output group as at least more than one second output group, and when an output delay signal, which is not output within the specific unit time, is caused by stopping output due to at least partial overlapping of the unit time and the time of stopping output of the signal and the total output amount of the signal in the specific unit time is reduced, setting the signal output schedule by defining the output amount of the signal equivalent to the output amount of the signal in the first output group out of the total output amount of the signal of no reduction as the first output group out of a reduced total output amount of the signal in the specific unit time and defining a difference between the reduced total output amount of the signal and the output amount of the signal in the first output group as at least one second output group.

According to another aspect of this invention, in a method for outputting a signal, the signal for a data communication apparatus is output to the data communication apparatus in a constant total output amount of the signal per a unit time and output of the signal is stopped during a certain time of stopping output of the signal. The method includes signal output schedule setting for setting a signal output schedule for each of the unit time by defining a certain output amount of the signal out of the total output amount of the signal per the unit time as a first output group and further defining a difference between the total output amount of the signal per the unit time and the output amount of the signal in the first output group as at least more than one second output group, and when an output delay signal, which is not output within a specific unit time, is caused by stopping output due to at least partial overlapping of the unit time and the time of stopping output of the signal, and therefore the total output amount of the signal in the specific unit time is reduced, for setting the signal output schedule for outputting the output delay signal, which is not output within the specific unit time, in another unit time following the specific unit time by reducing the output amount of the signal in at least one second output group in the other unit time.

According to another aspect of this invention, in a method for outputting a signal, the signal for a data communication apparatus is output to the data communication apparatus in a constant total output amount of the signal per a unit time and output of the signal is stopped during a certain time of stopping output of the signal. The method includes signal output schedule setting for setting a signal output schedule for each of the unit time by defining a certain output amount of the signal out of the total output amount of the signal per the unit time as a first output group and further defining a difference between the total output amount of the signal per the unit time and the output amount of the signal in the first output group as at least more than one second output group, and when an output delay signal, which is not output within the specific unit time, is caused by stopping output due to at least partial overlapping of the unit time and the time of stopping output of the signal and the total output amount of the signal in the specific unit time is reduced, for setting the signal output schedule by defining the output amount of the signal equivalent to the output amount of the signal in the first output group out of the total output amount of the signal of no reduction as the first output group out of a reduced total output amount of the signal in the specific unit time and defining a difference between the reduced total output amount of the signal and the output amount of the signal in the first output group as at least one second output group.

According to another aspect of this invention, in a computer-readable storage medium storing a computer-executable program for operating a computer to output a signal for a data communication apparatus to the data communication apparatus in a constant total output amount of the signal per a unit time and to stop output of the signal during a certain time of stopping output of the signal. The computer-executable program includes signal output schedule setting code segment for setting a signal output schedule for each of the unit time by defining a certain output amount of the signal out of the total output amount of the signal per the unit time as a first output group and further defining a difference between the total output amount of the signal per the unit time and the output amount of the signal in the first output group as at least more than one second output group, and when an output delay signal, which is not output within a specific unit time, is caused by stopping output due to at least partial overlapping of the unit time and the time of stopping output of the signal, and therefore the total output amount of the signal in the specific unit time is reduced, setting the signal output schedule for outputting the output delay signal, which is not output within the specific unit time, in another unit time following the specific unit time by reducing the output amount of the signal in at least one second output group in the other unit time.

According to another aspect of this invention, in a computer-readable storage medium storing a computer-executable program for operating a computer to output a signal for a data communication apparatus to the data communication apparatus in a constant total output amount of the signal per a unit time and to stop output of the signal during a certain time of stopping output of the signal. The computer-executable program includes signal output schedule setting code segment for setting a signal output schedule for each of the unit time by defining a certain output amount of the signal out of the total output amount of the signal per the unit time as a first output group and further defining a difference between the total output amount of the signal per the unit time and the output amount of the signal in the first output group as at least more than one second output groups, and when an output delay signal, which is not output within the specific unit time, is caused by stopping output due to at least partial overlapping of the unit time and the time of stopping output of the signal and the total output amount of the signal in the specific unit time is reduced, setting the signal output schedule by defining the output amount of the signal equivalent to the output amount of the signal in the first output group out of the total output amount of the signal of no reduction as the first output group out of a reduced total output amount of the signal in the specific unit time and defining a difference between the reduced total output amount of the signal and the output amount of the signal in the first output group as at least one second output group.

Further features and applications of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

Other objects features, and advantages of the invention will be apparent from the following description when taken in conjunction with the accompany drawings.

### BRIEF DESCRIPTION OF THE DRAWINGS

FIG. 1 shows a block chart illustrating a configuration in Embodiment 1, 2, 3, and 4 of this invention;

FIG. 2 shows a block chart illustrating a configuration in Embodiment 5 and 6 of this invention;

FIG. 3 shows a block chart illustrating a configuration in the related art;

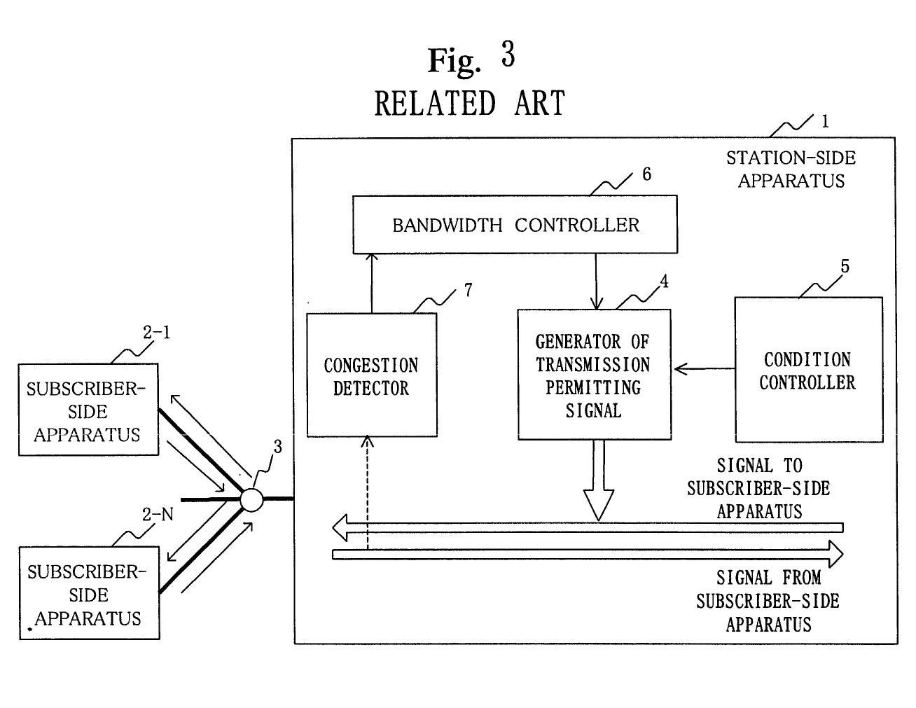

FIG. 4 shows an explanatory chart of operations when a ranging window is opened;

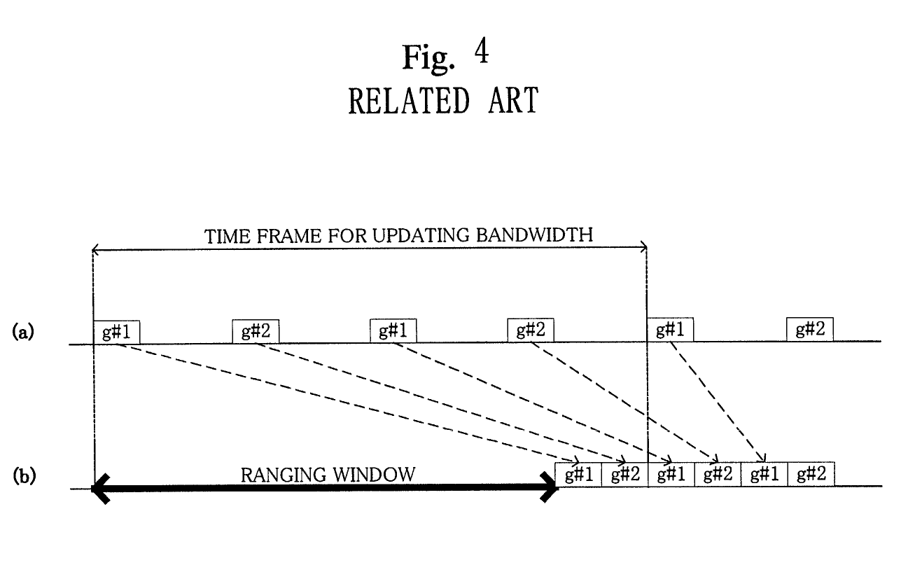

FIG. 5 shows an explanatory chart of operations in dynamic bandwidth allocation;

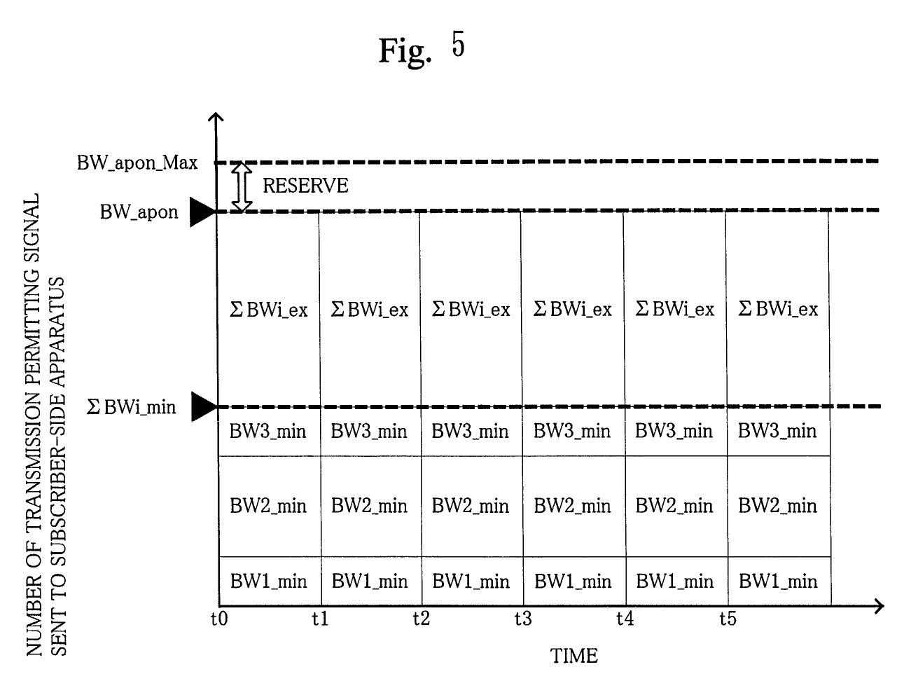

FIG. 6 shows a time chart of operations according to the related art;

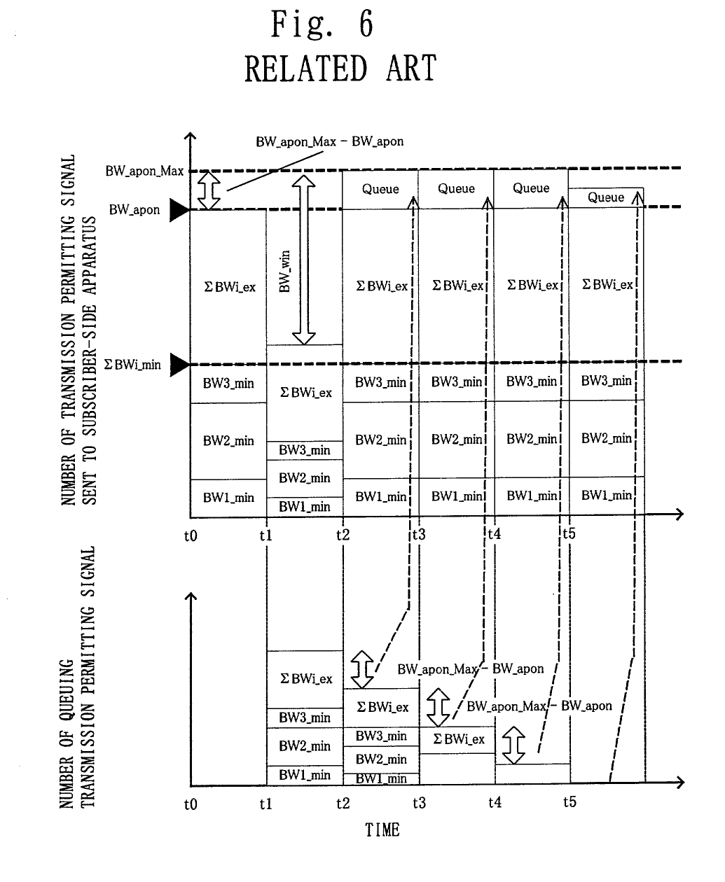

FIG. 7 shows a time chart of operations in Embodiment 1 of this invention;

FIG. 8 shows a time chart of operations in Embodiment 2 of this invention;

FIG. 9 shows a time chart of operations in Embodiment 3 of this invention;

FIG. 10 shows a time chart of operations in Embodiment 4 of this invention;

FIG. 11 shows a time chart of operations in Embodiment 5 of this invention; and

FIG. 12 shows a time chart of operations in Embodiment 6 of this invention.

### DETAILED DESCRIPTION OF THE PREFERRED EMBODIMENTS

Embodiment 1.

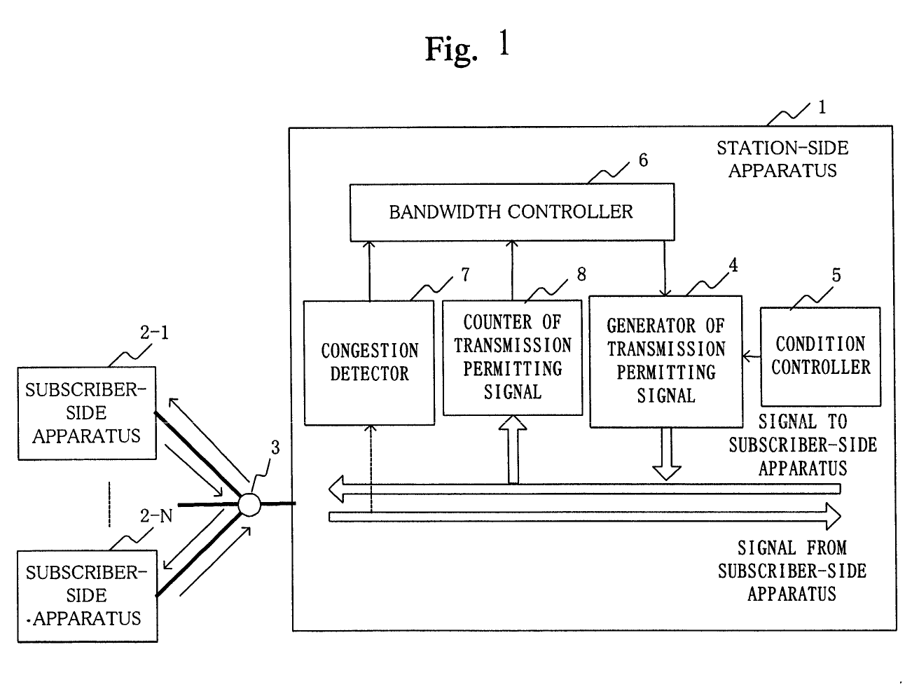

FIG. 1 shows a configuration chart in embodiments of this invention.

FIG. 1 illustrates the station-side apparatus 1, i.e., equivalent to an apparatus for outputting the signal, the subscriber-side apparatuses 2-1˜2-N, i.e., equivalent to data communication apparatuses, a star coupler 3, the generator 4 of the transmission permitting signal, the condition controller 5, the bandwidth controller 6, the congestion detector 7, and a counter 8 of the transmission permitting signal.

The generator 4 of the transmission permitting signal functions as a signal generator and a signal storing unit. The generator 4 of the transmission permitting signal generates the transmission permitting signal, and places in a queue (stores) the transmission permitting signal which is not output to the subscriber-side apparatuses 2-1˜2-N due to ranging.

As stated, while the ranging window is opened, output to other subscriber-side apparatuses 2-1˜2-N is stopped. Therefore, a time of opening the ranging window is a time of stopping output of the signal.

The transmission permitting signal, which is output to the subscriber-side apparatus in delay due to queuing, is called as an output delay signal.

The condition controller 5 manages a condition of the subscriber-side apparatuses 2-1˜2-N, and instructs the generator 4 of the transmission permitting signal to open the ranging window.

The bandwidth controller 6 sets a signal output schedule for outputting the transmission permitting signal to the subscriber-side apparatuses 2-1˜2-N for each unit time, and functions as a signal output schedule setter.

The congestion detector 7 detects a bandwidth usage condition (congestion condition) of the subscriber-side apparatuses 2-1˜2-N, and informs a detected result to the bandwidth controller 6.

The counter 8 of the transmission permitting signal functions as a measuring unit, and counts a number (stored amount) of the transmission permitting signal queuing in the generator 4 of the transmission permitting signal.

With reference to FIG. 1, operations are explained.

The bandwidth controller 6 allocates the excess bandwidth to a subscriber-side apparatus in a congestion state based on the bandwidth usage condition of the subscriber-side apparatuses 2-1˜2-N provided by the congestion detector 7. The excess bandwidth is a bandwidth obtained by deducting a sum of the minimum guaranteed bandwidth (minimum guaranteed output amount) for each of the subscriber-side apparatuses from the APON bandwidth.

The bandwidth controller 6 reads the number of the transmission permitting signal which could be sent to each of the subscriber-side apparatuses, or the number of the transmission permitting signal which could not be sent to each of the subscriber-side apparatuses, counted by the counter 8 of the transmission permitting signal, from the counter 8 of the transmission permitting signal.

The condition controller 5 manages the condition of the subscriber-side apparatuses 2-1˜2-N. When a failure occurs or new subscriber-side apparatus is being installed, the condition controller 5 instructs the generator 4 of the transmission permitting signal to open the ranging window. Thus, the condition controller 5 instructs the generator 4 of the transmission permitting signal to send the transmission permitting signal for ranging to a subscriber-side apparatus of which delay time is unknown, such as a newly installed subscriber-side apparatus.

After the generator 4 of the transmission permitting signal opens the ranging window based on an instruction from the condition controller 5, the counter 8 of the transmission permitting signal counts the number of the transmission permitting signal queuing (stored) in the generator 4 of the transmission permitting signal, and the bandwidth controller 6 obtains the number (stored amount) of the queuing transmission permitting signal from the counter 8 of the transmission permitting signal.

After the ranging window is closed, the bandwidth controller 6 deducts the number of the queuing transmission permitting signal and the sum of the minimum guaranteed bandwidth from the available APON bandwidth, and allocates a remaining bandwidth as the excess bandwidth to the subscriber-side apparatus in the congestion state.

Since the bandwidth for the queuing transmission permitting signal is secured, the generator 4 of the transmission permitting signal can send the queuing transmission permitting signal in short time.

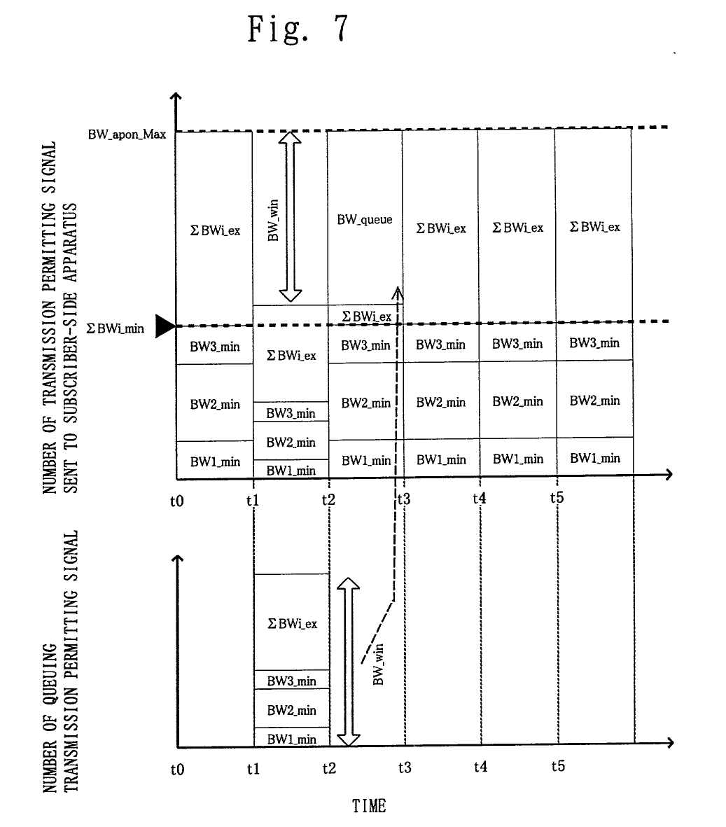

With reference to a time chart of FIG. 7, an example of a processing procedure in the station-side apparatus 1 according to Embodiment 1 is explained.

From time t0 to time t1, an excess bandwidth (ΣBWi_ex), which is the APON maximum bandwidth (BW_apon_Max) minus the sum of minimum guaranteed bandwidth (ΣBWi_min), is allocated to the subscriber-side apparatus in the congestion state.

Then, from time t1 to time t2, when the ranging window is opened, the transmission permitting signal equivalent to the bandwidth (BW_win) occupied by the ranging window queues in the generator 4 of the transmission permitting signal. The counter 8 of the transmission permitting signal counts the number of the queuing transmission permitting signal, and informs a counting result to the bandwidth controller 6.

Then, from t2 to time t3, the bandwidth controller 6 allocates the excess bandwidth (ΣBWi_ex), which is the APON maximum bandwidth (BW_apon_Max) minus a bandwidth (BW_queue=BW_win) equivalent to the queuing signal and the sum of the minimum guaranteed bandwidth (ΣBWi_min), to the subscriber-side apparatus in the congestion state.

The excess bandwidth (ΣBWi_ex) can be obtained by following expression 1:

ΣBWi_{—}ex=BW_{—}apon_{—}Max−BW_{—}win−ΣBWi_{—}min (Expression 1)

After time t3, same as a procedure in time t0 to time t1, the excess bandwidth (ΣBWi_ex), which is the APON maximum bandwidth (BW_apon_Max) minus the sum of the minimum guaranteed bandwidth (ΣBWi_min), is allocated to the subscriber-side apparatus in the congestion state.

As stated, in Embodiment 1, the queuing transmission permitting signal is sent immediately after the ranging window is closed, prior to other transmission permitting signals. Therefore, a delay in transmission of data can be reduced, and degradation of communication quality in the CBR path can be reduced. Further, since it is not necessary to prepare the reserve bandwidth for the ranging window, the bandwidth can be utilized effectively.

In the above explanations, all the queuing transmission permitting signals are sent between t2 and t3. However, it is also possible to output only the transmission permitting signal equivalent to the minimum guaranteed 11 bandwidth (BW1_min˜BW3_min) among the queuing transmission permitting signals, and abandon other transmission permitting signals. Embodiment 2.

Embodiment 1 is intended to reduce the delay in sending the queuing transmission permitting signals and utilize the bandwidth effectively when the transmission permitting signal, which could not be sent due to the opening of ranging window, queues. In the following description, explanations are made on an embodiment of applying this invention to a case in which the transmission permitting signal does not queue.

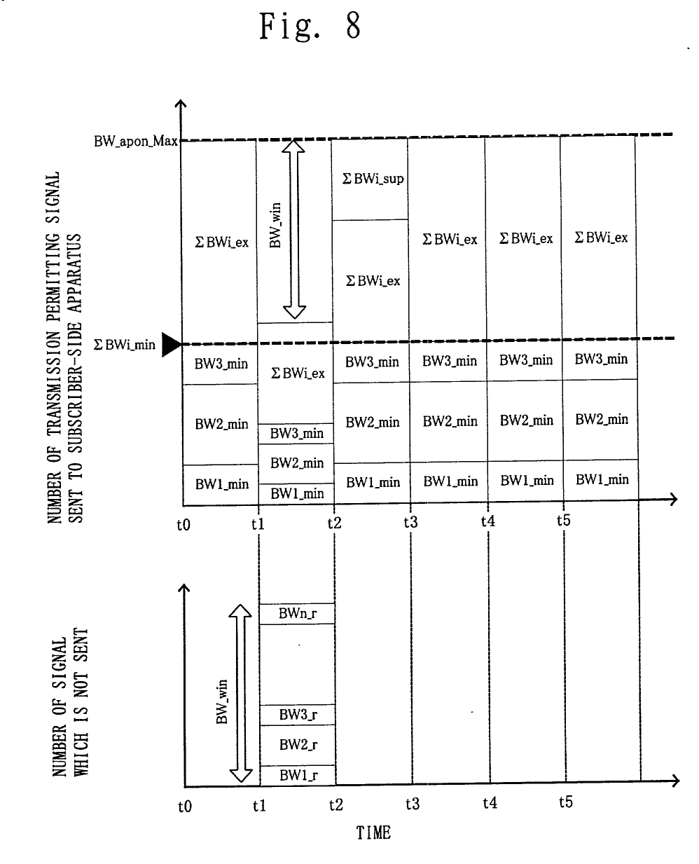

A configuration is same as FIG. 1. However, unlike Embodiment 1, the transmission permitting signal does not queue in the generator 4 of the transmission permitting signal in Embodiment 2. With reference to a time chart of FIG. 8, operations are explained.

From time t0 to time t1, the excess bandwidth (ΣBWi_ex), which is the APON maximum bandwidth (BW_apon_Max) minus the sum of the minimum guaranteed bandwidth (ΣBWi_min), is allocated to the subscriber-side apparatus in the congestion state.

From time t1 to time t2, it can be found out that the number of the transmission permitting signal (BWi_r) which could not be sent to each of the subscriber-side apparatuses due to the opening of ranging window, or that the number of the transmission permitting signal which could be sent to each of the subscriber-side apparatuses. When the sum of the transmission permitting signal sent to each of the subscriber-side apparatuses does not reach the minimum guaranteed bandwidth (in FIG. 8, since the sum of BW1_min BW3_min does not reach ΣBWi_min, it is insufficient to the minimum guaranteed bandwidth), the transmission permitting signal equivalent to a bandwidth (BWi_make) for making up for the bandwidth lacked for reaching the minimum guaranteed bandwidth in a specific time frame is sent prior to other transmission permitting signals in a next time frame. BWi_make can be obtained by the following expression:

BWi_{—}make=BWi_{—}r−BWi_{—}ex

(BWi_{—}r>BWi_ex) (Expression 2)

From time t2 to time t3, the excess bandwidth (ΣBWi_ex), which is the APON maximum bandwidth (BW_apon_Max) minus the bandwidth (ΣBWi_make) for making up for the bandwidth lacked for reaching the minimum guaranteed bandwidth in a previous time frame of time t1 to t2 and the sum of the minimum guaranteed bandwidth, is allocated to the subscriber-side apparatus in the congestion state.

ΣBWi_ex as in following expression 3 is allocated.

ΣBWi_{—}ex=BW_{—}apon_{—}Max−ΣBWi_{—}min−ΣBWi_{—}make (Expression 3)

As stated, in Embodiment 2, the transmission permitting signal for making up for the bandwidth lacked for reaching the minimum guaranteed bandwidth is sent immediately after the ranging window is closed, prior to other transmission permitting signals. Therefore, it is possible to reduce the delay in transmission of data and degradation of communication quality in the CBR path. Further, since it is not necessary to prepare the reserve bandwidth for the ranging window, the bandwidth can be utilized effectively.

In the above explanations, only the transmission permitting signal for making up for the bandwidth lacked for reaching the minimum guaranteed bandwidth (BW1_min˜BW3_min) is output among the transmission permitting signals which were not sent in previous time frame. However, it is also possible to output all the transmission permitting signals which were not sent in previous time frame.

Embodiment 3.

Embodiment 1 and 2 are intended to reduce the delay in sending the transmission permitting signals and utilize the bandwidth effectively when no priority is set to the transmission permitting signal sent to each of the subscriber-side apparatuses. Next, Embodiment 3, where various priorities are set to the transmission permitting signal sent to each of the subscriber-side apparatuses, is explained.

A configuration is same as FIG. 1. Operations are explained.

The bandwidth controller 6 allocates a transmission permitting signal of high priority to a connection intolerant to the delay in transmission of data. The bandwidth controller 6 allocates a transmission permitting signal of low priority to a connection intolerant to the delay in transmission of data.

The bandwidth controller 6 sends the transmission permitting signal of high priority prior to that of low priority in accordance with a usage condition of the bandwidth of the subscriber-side apparatuses 2-1˜2-N provided by the congestion detector 7. If some bandwidth is still available, the transmission permitting signal of low priority is sent.

The bandwidth controller 6 also reads the number of the transmission permitting signal, which could be sent to each of the subscriber-side apparatuses, or the number of the transmission permitting signal, which could not be sent, from the counter 8 of the transmission permitting signal.

The condition controller 5 manages the condition of the subscriber-side apparatuses 2-1˜2-N. When a failure occurs or new subscriber-side apparatus is being installed, the condition controller 5 instructs the generator 4 of the transmission permitting signal to open the ranging window.

After the condition controller 5 opens the ranging window, the bandwidth controller 6 obtains a number of the queuing transmission permitting signal.

After the ranging window is closed, the bandwidth controller 6 deducts the number of the queuing transmission permitting signal and a sum of a bandwidth occupied by the transmission permitting signal of high priority from an available bandwidth of APON, and allocates a remaining bandwidth for the transmission permitting signal of low priority.

Since the bandwidth is secured for the queuing transmission permitting signal, the generator 4 of the transmission permitting signal can send the queuing transmission permitting signal in short time.

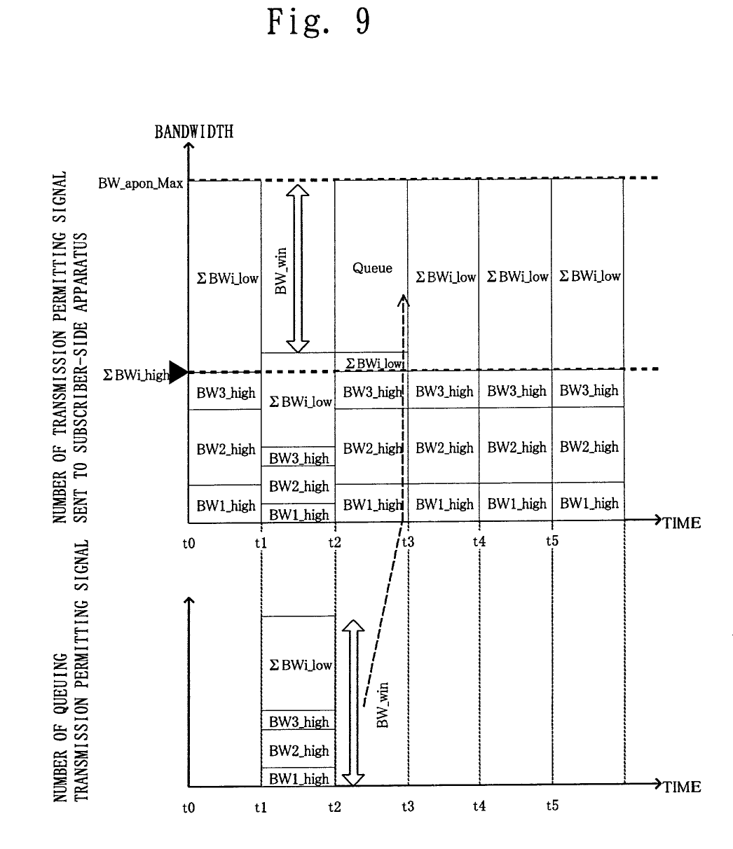

With reference to a time chart of FIG. 9, an example is explained.

From time t0 to time t1, a bandwidth, which is the APON maximum bandwidth (BW_apon_Max) minus the sum of a bandwidth occupied by the transmission permitting signal of high priority (ΣBWi_high), is allocated to the transmission permitting signal of low priority.

Then, from time t1 to time t2, when the ranging window is opened, a transmission permitting signal equivalent to the bandwidth (BW_win) occupied by the ranging window queues.

Then, from t2 to time t3, a bandwidth, which is the APON maximum bandwidth (BW_apon_Max) minus the bandwidth (BW_win) equivalent to the queuing signal and the sum of the bandwidth occupied by the transmission permitting signal of high priority (ΣBWi_high), is allocated to the transmission permitting signal of low priority. Namely, ΣBWi_low as in following expression 4 is allocated to the transmission permitting signal of low priority.

ΣBWi_{—}low=BW_{—}apon_{—}Max−BW_{—}win−ΣBWi_{—}high (Expression 4)

As stated, according to this Embodiment, the queuing transmission permitting signal is sent immediately after the ranging window is closed. Therefore, the delay in transmission of data can be reduced, and degradation of communication quality in the CBR path can be reduced. Further, since it is not necessary to prepare the reserve bandwidth for the ranging window, the bandwidth can be utilized effectively.

Embodiment 4.

Embodiment 3 is intended to reduce the delay in sending the queuing transmission permitting signals and utilize the bandwidth effectively when the transmission permitting signal, which could not be sent due to the opening of ranging window, queues. Embodiment 4 is intended for a case in which the transmission permitting signal does not queue.

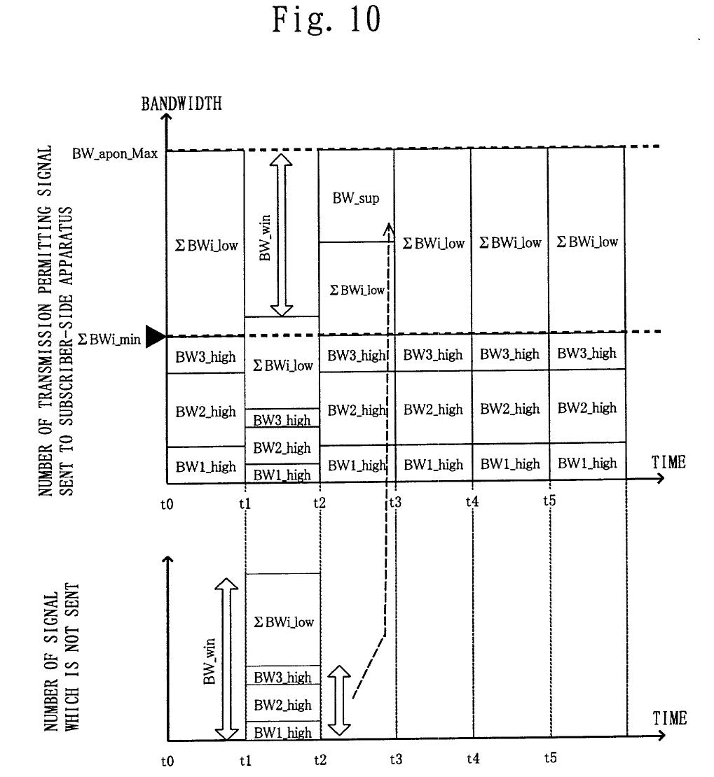

A configuration is same as FIG. 1. However, unlike Embodiment 3, the transmission permitting signal does not queue in the generator 4 of the transmission permitting signal. With reference to FIG. 10, operations are explained.

From time t0 to time t1, a bandwidth, which is the APON maximum bandwidth (BW_apon_Max) minus the sum of the bandwidth occupied by the transmission permitting signal of high priority (ΣBWi_high), is allocated to the transmission permitting signal of low priority.

From time t1 to time t2, it is possible to know the number of the transmission permitting signal which could not be sent to each of the subscriber-side apparatuses due to the opening of ranging window. When the sum of the transmission permitting signal of high priority sent to each of the subscriber-side apparatuses does not reach a desired number (in FIG. 10, since the sum of BW1_high˜BW3 high sent between t1˜t2 does not reach ΣBWi_min, it is insufficient to the desired number), the transmission permitting signal equivalent to a bandwidth (BWi_makehigh) for making up for the number of the transmission permitting signal lacked for reaching the number of high priority in a specific time frame is sent prior to other transmission permitting signals in the next time frame. BWi_makehigh can be obtained by the following expression:

BWi_{—}makehigh=BWi_{—}r−BWi_{—}low

(BWi_r>BWi_ex) (Expression 5)

From time t2 to time t3, a bandwidth, which is the APON maximum bandwidth (BW_apon_Max) minus a bandwidth equivalent to the sum of the transmission permitting signals of high priority (ΣBWi_makehigh), which could not be sent in a previous time frame, and the sum of the transmission permitting signal of high priority (ΣBWi_high), is allocated to the transmission permitting signal of low priority.

BWi_{—}low=BW_{—}apon_{—}Max−BW_{—}high−ΣBWi_{—}makehigh (Expression 6)

As stated, according to this Embodiment, the transmission permitting signal of high priority, which could not be sent in the previous time frame, is sent immediately after the ranging window is closed. Therefore, the delay in transmission of data and degradation of communication quality in the CBR path can be reduced. Further, since it is not necessary to prepare the bandwidth for the ranging window, the bandwidth can be utilized effectively.

Embodiment 5.

In Embodiment 1, 2, 3, and 4, the transmission permitting signal is sent prior to other signals immediately after the ranging window is closed. Consequently, the delay is reduced, and the bandwidth is utilized effectively. In the following description, an embodiment for controlling the bandwidth before the ranging window is opened is explained.

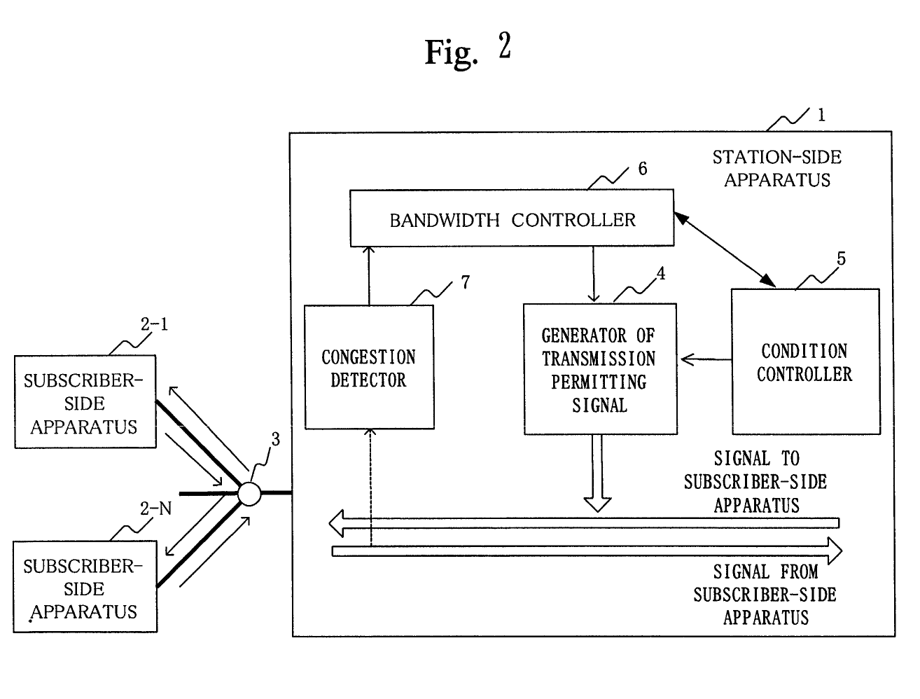

FIG. 2 shows a configuration chart in an embodiment of this invention.

FIG. 2 illustrates the station-side apparatus 1, the subscriber-side apparatuses 2-1˜2-N, the star coupler 3, the generator 4 of the transmission permitting signal, the condition controller 5, the bandwidth controller 6, and the congestion detector 7.

Operations are explained. The condition controller 5 instructs the bandwidth controller 6 to allocate the remaining bandwidth after deducting the bandwidth for the ranging window to each subscriber-side apparatus, before the ranging window is opened. The bandwidth controller 6 deducts the bandwidth for the ranging window and the sum of the minimum guaranteed bandwidth from the APON maximum bandwidth, and allocates a remaining bandwidth as the excess bandwidth to the subscriber-side apparatus in the congestion state. When the allocation of the bandwidth is completed, the bandwidth controller 6 permits the condition controller 5 to open the ranging window.

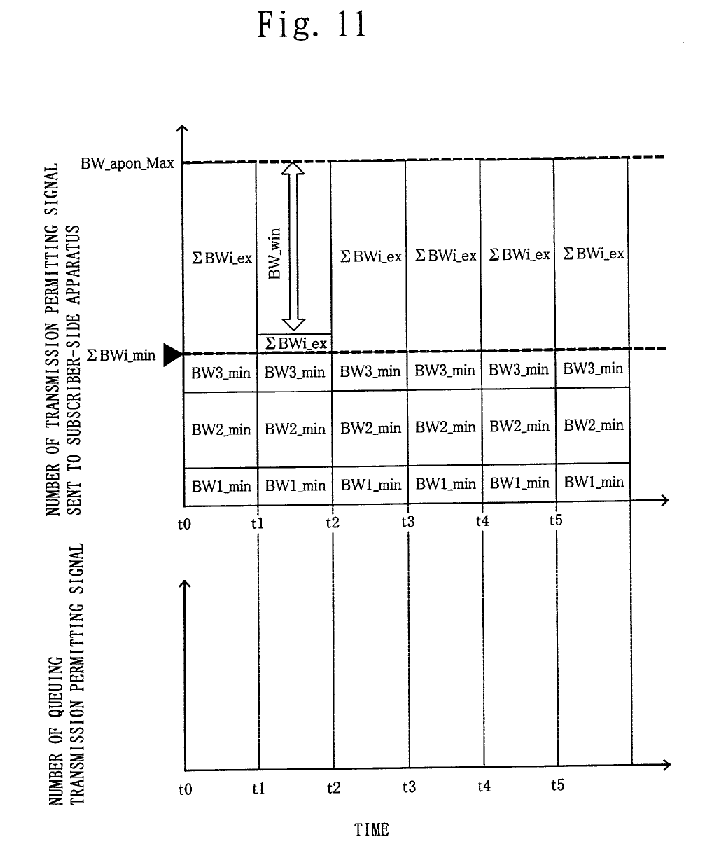

With reference to a time chart of FIG. 11, an example is explained.

From time t0 to time t1, the excess bandwidth (ΣBWi_ex), which is the APON maximum bandwidth (BW_apon_Max) minus the sum of the minimum guaranteed bandwidth (ΣBWi_min), is allocated to the subscriber-side apparatus in the congestion state.

Then, from time t1 to time t2, before the ranging window is being opened, the excess bandwidth (ΣBWi_ex), which is the APON maximum bandwidth (BW_apon_Max) minus the bandwidth (BW_win) to be occupied by the ranging window and the sum of the bandwidth for the minimum guaranteed bandwidth (ΣBWi_min), is allocated to the subscriber-side apparatus in the congestion state. The sum of the minimum guaranteed bandwidth (ΣBWi_min) allocated between t1 and t2 is the same amount as when the ranging window is not opened.

Then, from t2 to time t3, the excess bandwidth (ΣBWi_ex), which is the APON maximum bandwidth (BW_apon_Max) minus the sum of the minimum guaranteed bandwidth (ΣBWi_min), is allocated to the subscriber-side apparatus in the congestion state.

As stated, the bandwidth excluding the bandwidth for the ranging window is allocated to each subscriber-side apparatus before the ranging window is opened, then the calculation for the allocation can be carried out without any influence from the ranging window. Accordingly, it is possible to avoid the number of the transmission permitting signal sent to each of the subscriber-side apparatus being less than the minimum guaranteed bandwidth. It is also possible to reduce the delay for the CBR. Further, since it is not necessary to prepare the reserve bandwidth for the ranging window, the bandwidth can be utilized effectively.

Embodiment 6.

Embodiment 5 is intended to reduce the delay and utilize the bandwidth effectively when no priority is set to the transmission permitting signal sent to each of the subscriber-side apparatus. Next, Embodiment 6, where various priorities are set to the transmission permitting signal sent to each of the subscriber-side apparatus, is explained.

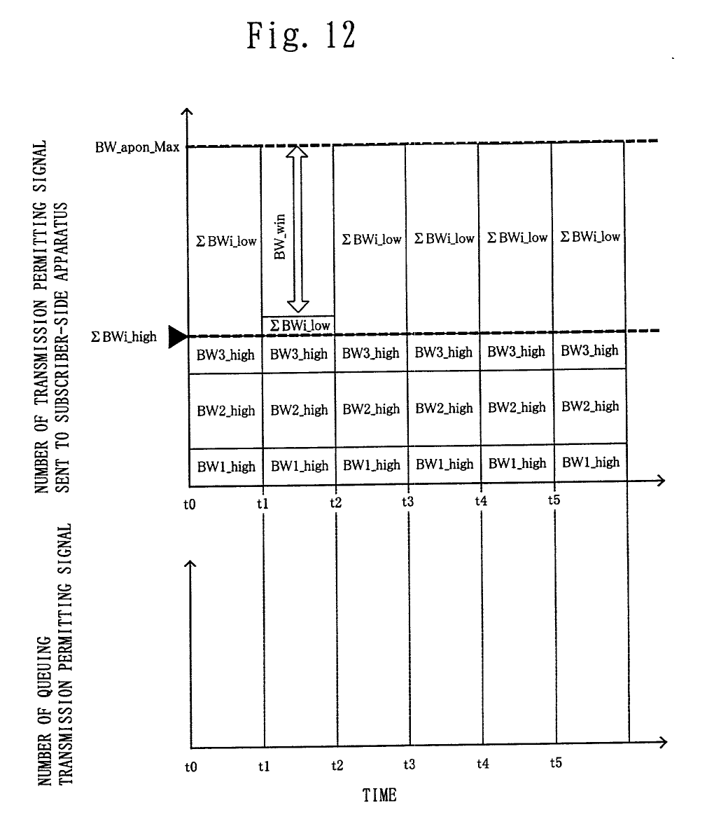

A configuration is same as FIG. 2. With reference to a time chart of FIG. 12, operations are explained.

From time t0 to time t1, the excess bandwidth (ΣBWi_ex), which is the APON maximum bandwidth (BW_apon_Max) minus the sum of the transmission permitting signals of high priority, is allocated to the transmission permitting signal of low priority.

From t1 to t2, before the ranging window is being opened, the excess bandwidth (ΣBWi_ex), which is the APON maximum bandwidth (BW_apon_Max) minus the bandwidth (BW_win) to be occupied by the ranging window and the sum of the bandwidth for the transmission permitting signals of high priority (ΣBWi_high), is allocated to the transmission permitting signals of low priority. The sum of the bandwidth for the transmission permitting signals of high priority (ΣBWi_high) allocated between t1 and t2 is the same amount as when the ranging window is not opened.

From time t2 to time t3, the excess bandwidth (ΣBWi_ex), which is the APON maximum bandwidth (BW_apon_Max) minus the sum of the bandwidth for the transmission permitting signals of the high quality, is allocated to the transmission permitting signal of low priority.

As stated, the bandwidth excluding the bandwidth for the ranging window is allocated to each subscriber-side apparatus before the ranging window is opened, and the calculation for the allocation of the bandwidth can be carried out without any influence from the ranging window. Therefore, it is possible that the transmission permitting signal of high priority is sent to each of the subscriber-side apparatus prior to the signals of low priority. It is also possible to reduce the delay in data transmission in CBR path. Further, since it is not necessary to prepare the reserve bandwidth for the ranging window, the bandwidth can be utilized effectively.

In Embodiment 1-6, explanations are made on the apparatus for outputting the signal. It is also possible to realize a method for outputting the signal according to this invention by following a same procedure.

Further, the generator 4 of the transmission permitting signal, the condition controller 5, the bandwidth controller 6, the congestion detector 7, and the counter 8 of the transmission permitting signal can be also computer programs. The programs can be stored in a computer readable medium.

Characteristics of this invention as explained can be summarized as follows.

A bandwidth management system according to this invention includes a function for determining the number of the transmission permitting signal which should be sent within a unit time. Or, the bandwidth management system according to this invention includes the function for determining the number of the transmission permitting signal which should be sent within the unit time and a function for counting the number of the transmission permitting signal which could be sent. Or, the bandwidth management system according to this invention includes the function for determining the number of the transmission permitting signal which should be sent within the unit time and a function for counting a number of the transmission permitting signal which could not be sent.

The bandwidth management system according to this invention re late s to the ATM-PON system, in which the station-side apparatus includes the congestion detector and the bandwidth controller and the station-side apparatus adjusts a rate of sending the transmission permitting signal to the subscriber-side apparatus based on a usage condition of an allocated bandwidth. In the ATM-PON system, the counter of the transmission permitting signal is provided, and the number of the transmission permitting signal, which queues due to the opening of ranging window is opened, is counted, then when the ranging window is closed, the queuing transmission permitting signal is sent prior to other signals.

Further, the bandwidth management system according to this invention relates to the ATM-PON system, in which the station-side apparatus includes the congestion detector and the bandwidth controller, and the station-side apparatus adjusts the rate of sending the transmission permitting signal to the subscriber-side apparatus based on the usage condition of the allocated bandwidth. In the ATM-PON system, the counter of the transmission permitting signal is provided. When the number of the transmission permitting signal sent to the subscriber-side apparatus does not reach the minimum guaranteed bandwidth due to the opening of ranging window, a bandwidth for making up for the number of the transmission permitting signal lacked for reaching the minimum guaranteed bandwidth is allocated, after the ranging window is closed.

Further, in the bandwidth management system according to this invention, various priority is set to the transmission permitting signal. After the ranging window is closed, the queuing transmission permitting signal and the transmission permitting signal of high priority are sent prior to other signals.

Further, in the bandwidth management system according to this invention, various priority is set to the transmission permitting signal. When the number of the transmission permitting signal of high priority sent to the subscriber-side apparatus does not reach a desired level, due to the opening of ranging window, a bandwidth for making up for the number of the transmission permitting signal lacked for reaching the number of high priority is allocated, after the ranging window is closed.

In the bandwidth management system according to this invention, before the ranging window is opened, the bandwidth after deducting the bandwidth for the ranging window is allocated.

Further, in the bandwidth management system according to this invention, various priority is set to the transmission permitting signal. Before the ranging window is opened, the bandwidth is allocated in accordance with the priority set to each transmission permitting signal.

As stated, according to this invention, the queuing transmission permitting signal due to the opening of ranging window, is sent immediately after the ranging window is closed. Therefore, the delay in data transmission can be reduced. Further, since it is not necessary to prepare the reserve bandwidth specialized for transmitting the queuing transmission permitting signal, the bandwidth can be utilized effectively.

Further, according to this invention, the number of the transmission permitting signal, which could not be sent due to the opening of ranging window, is set immediately after the ranging window is closed. Therefore, the delay in data transmission can be reduced. Further, since it is not necessary to prepare the reserve bandwidth specialized for transmitting the queuing transmission permitting signal, the bandwidth can be utilized effectively.

Further, according to this invention, out of the bandwidth obtained by subtracting the bandwidth for the ranging window, the minimum guaranteed bandwidth is firstly allocated before the ranging window is opened. Therefore, the delay in the data transmission in the CBR path, caused by the opening of ranging window, can be reduced. Further, since it is not necessary to prepare the reserve bandwidth specialized for transmitting the queuing transmission permitting signal, the bandwidth can be utilized effectively.

Further, according to this invention, before the ranging window is opened, the bandwidth of low priority is regulated. Therefore, the delay in the data transmission in the CBR path, caused by the opening of ranging window, can be reduced.

Having thus described several particular embodiments of the invention, various alterations, modifications, and improvements will readily occur to those skilled in the art. Such alterations, modifications, and improvements are intended to be part of this disclosure, and are intended to be within the spirit and scope of the invention. Accordingly, the foregoing description is by way of example only and is limited only as defined in the following claims and the equivalents thereto.

What is claimed is:

1. An apparatus for outputting a signal, wherein the signal for a data communication apparatus is output to the data communication apparatus in a constant total output amount of the signal per a unit time and output of the signal is stopped during a certain time of stopping output of the signal, the apparatus comprising a signal output schedule setter for setting a signal output schedule for each of the unit time by defining a certain output amount of the signal out of the total output amount of the signal per the unit time as a first output group and further defining a difference between the total output amount of the signal per the unit time and the output amount of the signal in the first output group as at least more than one second output group, and when an output delay signal, which is not output within a specific unit time, is caused by stopping output due to at least partial overlapping of the specific unit time and the time of stopping output of the signal, and therefore the total output amount of the signal in the specific unit time is reduced, for setting the signal output schedule for outputting the output delay signal, which is not output within the specific unit time, in another unit time following the specific unit time by reducing the output amount of the signal in at least one second output group in the other unit time.

2. The apparatus for outputting the signal of claim 1, further comprising:
a signal generator for generating the signal;
a signal storing unit for storing the output delay signal, which is not output within the specific unit time in which output is originally scheduled by the signal output schedule setter by stopping output due to at least partial overlapping of the specific unit time and the time of stopping output of the signal, out of the signals generated by the signal generator; and
a measuring unit for measuring a stored amount of the output delay signal stored by the storing unit,
wherein the signal output schedule setter reduces the output amount of the signal in at least one second output group in the other unit time following the specific unit time in which the output delay signal is originally scheduled to be output and sets the signal output schedule for outputting the output delay signal in the other unit time, based on the stored amount of the signal measured by the measuring unit.

3. The apparatus for outputting the signal of claim 1, further comprising:
a signal generator for generating the signal; and
a measuring unit for measuring a signal amount of the output delay signal, which is not output within the specific unit time in which output is originally scheduled by the signal output schedule setter by stopping output due to at least partial overlapping of the specific unit time and the time of stopping output of the signal, out of the signals which have not been generated by the signal generator,
wherein the signal output schedule setter reduces the output amount of the signal in at least one second output group in the other unit time following the specific unit time in which the output delay signal is originally scheduled to be output and sets the signal output schedule for outputting the output delay signal in the other unit time based on the signal amount of the output delay signal measured by the measuring unit.

4. The apparatus for outputting the signal of claim 2, wherein the signal output schedule setter defines a part of the output delay signal as a first group signal for being output in the first output group and a remaining part of the output delay signal as a second group signal for being output in the second output group, and sets the signal output schedule for outputting the first group signal in the other unit time by reducing the output amount of the signal in at least one second output group in the other unit time.

5. An apparatus for outputting a signal, wherein the signal for a data communication apparatus is output to the data communication apparatus in a constant total output amount of the signal per a unit time and output of the signal is stopped during a certain time of stopping output of the signal, the apparatus comprising a signal output schedule setter for setting a signal output schedule for each of the unit time by defining a certain output amount of the signal out of the total output amount of the signal per the unit time as a first output group and further defining a difference between the total output amount of the signal per the unit time and the output amount of the signal in the first output group as at least more than one second output group, and when an output delay signal, which is not output within the specific unit time, is caused by stopping output due to at least partial overlapping of the unit time and the time of stopping output of the signal and the total output amount of the signal in the specific unit time is reduced, setting the signal output schedule by defining the output amount of the signal equivalent to the output amount of the signal in the first output group out of the total output amount of the signal of no reduction as the first output group out of a reduced total output amount of the signal in the specific unit time and defining a difference between the reduced total output amount of the signal and the output amount of the signal in the first output group as at least one second output group.

6. The apparatus for outputting the signal of claim 5, wherein the signal output schedule setter sets, when the total output amount of the signal in the specific unit time is reduced, before the time of stopping output of the signal, the signal output schedule by defining the output amount of the signal equivalent to the output amount of the signal in the first output group out of the total output amount of the signal of no reduction as the first output group out of a reduced total output amount of the signal in the specific unit time and defining a difference between the reduced total output amount of the signal and the output amount of the signal in the first output group as at least one of the second output groups.

7. The apparatus for outputting the signal of claim 1 connected to a plurality of data communication apparatuses via a plurality of transmission lines, wherein a data transmission permitting signal for permitting data transmission from each of the data communication apparatuses is output to each of the data communication apparatuses, and wherein the signal output schedule setter sets a signal output schedule for outputting the data transmission permitting signal.

8. The apparatus for outputting the signal of claim 7, wherein an adjusting amount for adjusting a difference in data transmission time due to a difference in a length of the transmission line of each of the data communication apparatuses is measured, and wherein output of the data transmission permitting signal is stopped during the time for measuring the adjusting amount for one of the data communication apparatuses as the time of stopping output of the signal.

9. The apparatus for outputting the signal of claim 1 for outputting the signals to a plurality of data communication apparatuses, wherein the signal output schedule setter defines a sum of a minimum guaranteed output amount which should be output to each of the data communication apparatuses at least within a unit time as the output amount of the signal in the first output group.

10. The apparatus for outputting the signal of claim 1 for outputting the signals to a plurality of data communication apparatuses, wherein the signal output schedule setter sets various priorities to the signal output to each of the data communication apparatuses, and defines a sum of output amount of the signal to which higher priority than a determined level is set as the output amount of the signal in the first output group.

11. A method for outputting a signal, wherein the signal for a data communication apparatus is output to the data communication apparatus in a constant total output amount of the signal per a unit time and output of the signal is stopped during a certain time of stopping output of the signal, the method comprising signal output schedule setting for setting a signal output schedule for each of the unit time by defining a certain output amount of the signal out of the total output amount of the signal per the unit time as a first output group and further defining a difference between the total output amount of the signal per the unit time and the output amount of the signal in the first output group as at least more than one second output group, and when an output delay signal, which is not output within a specific unit time, is caused by stopping output due to at least partial overlapping of the unit time and the time of stopping output of the signal, and therefore the total output amount of the signal in the specific unit time is reduced, for setting the signal output schedule for outputting the output delay signal, which is not output within the specific unit time, in another unit time following the specific unit time by reducing the output amount of the signal in at least one second output group in the other unit time.

12. The method for outputting the signal of claim 11, further comprising:
signal generating for generating the signal;
signal storing for storing the output delay signal, which is not output within the specific unit time in which output is originally scheduled by signal output schedule setting by stopping output due to at least partial overlapping of the specific unit time and the time of stopping output of the signal, out of the signals generated by signal generating; and
measuring for measuring a stored amount of the output delay signal stored by storing,
wherein signal output schedule setting reduces the output amount of the signal in at least one second output group in the other unit time following the specific unit time in which the output delay signal is originally scheduled to be output and sets the signal output schedule for outputting the output delay signal in the other unit time, based on the stored amount of the signal measured by measuring.

13. The method for outputting the signal of claim 11, further comprising:
signal generating for generating the signal; and
measuring for measuring a signal amount of the output delay signal, which is not output within the specific unit time in which output is originally scheduled by signal output schedule setting by stopping output due to at least partial overlapping of the specific unit time and the time of stopping output of the signal, out of the signals which have not been generated in signal generating,
wherein signal output schedule setting reduces the output amount of the signal in at least one second output group in the other unit time following the specific unit time in which the output delay signal is originally scheduled to be output and sets the signal output schedule for outputting the output delay signal in the other unit time based on the signal amount of the output delay signal measured by measuring.

14. A method for outputting a signal, wherein the signal for a data communication apparatus is output to the data communication apparatus in a constant total output amount of the signal per a unit time and output of the signal is stopped during a certain time of stopping output of the signal, the method comprising signal output schedule setting for setting a signal output schedule for each of the unit time by defining a certain output amount of the signal out of the total output amount of the signal per the unit time as a first output group and further defining a difference between the total output amount of the signal per the unit time and the output amount of the signal in the first output group as at least more than one second output group, and when an output delay signal, which is not output within the specific unit time, is caused by stopping output due to at least partial overlapping of the unit time and the time of stopping output of the signal and the total output amount of the signal in the specific unit time is reduced, for setting the signal output schedule by defining the output amount of the signal equivalent to the output amount of the signal in the first output group out of the total output amount of the signal of no reduction as the first output group out of a reduced total output amount of the signal in the specific unit time and defining a difference between the reduced total output amount of the signal and the output amount of the signal in the first output group as at least one second output group.

15. The method for outputting the signal of claim 11 communicating with a plurality of data communication apparatuses via a plurality of transmission lines, wherein a data transmission permitting signal for permitting data transmission from each of the data communication apparatuses is output to each of the data communication apparatuses, and wherein signal output schedule setting sets a signal output schedule for outputting the data transmission permitting signal.

16. The method for outputting the signal of claim 15, wherein an adjusting amount for adjusting a difference in data transmission time due to a difference in a length of the transmission line of each of the data communication apparatuses is measured, and wherein output of the data transmission permitting signal is stopped during the time for measuring the adjusting amount for one of the data communication apparatuses as the time of stopping output of the signal.

17. A computer-readable storage medium storing a computer-executable program for operating a computer to output a signal for a data communication apparatus to the data communication apparatus in a constant total output amount of the signal per a unit time and to stop output of the signal during a certain time of stopping output of the signal, the computer-executable program comprising:
signal output schedule setting code segment for setting a signal output schedule for each of the unit time by defining a certain output amount of the signal out of the total output amount of the signal per the unit time as a first output group and further defining a difference between the total output amount of the signal per the unit time and the output amount of the signal in the first output group as at least more than one second output group; and
when an output delay signal, which is not output within a specific unit time, is caused by stopping output due to at least partial overlapping of the unit time and the time of stopping output of the signal, and therefore the total output amount of the signal in the specific unit time is reduced, for setting the signal output schedule for outputting the output delay signal, which is not output within the specific unit time, in another unit time following the specific unit time by reducing the output amount of the signal in at least one second output group in the other unit time.

18. A computer-readable storage medium storing a computer-executable program for operating a computer to output a signal for a data communication apparatus to the data communication apparatus in a constant total output amount of the signal per a unit time and to stop output of the signal during a certain time of stopping output of the signal, the computer-executable program comprising:
signal output schedule setting code segment for setting a signal output schedule for each of the unit time by defining a certain output amount of the signal out of the total output amount of the signal per the unit time as a first output group and further defining a difference between the total output amount of the signal per the unit time and the output amount of the signal in the first output group as at least more than one second output groups; and
when an output delay signal, which is not output within the specific unit time, is caused by stopping output due to at least partial overlapping of the unit time and the time of stopping output of the signal and the total output amount of the signal in the specific unit time is reduced, setting the signal output schedule by defining the output amount of the signal equivalent to the output amount of the signal in the first output group out of the total output amount of the signal of no reduction as the first output group out of a reduced total output amount of the signal in the specific unit time and defining a difference between the reduced total output amount of the signal and the output amount of the signal in the first output group as at least one second output group.

19. The apparatus for outputting the signal of claim 3, wherein the signal output schedule setter defines a part of the output delay signal as a first group signal for being output in the first output group and a remaining part of the output delay signal as a second group signal for being output in the second output group, and sets the signal output schedule for outputting the first group signal in the other unit time by reducing the output amount of the signal in at least one second output group in the other unit time.
